(19) United States
(12) Patent Application Publication
(10) Pub. No.: US 2025/0156148 A1
(43) Pub. Date: May 15, 2025

(54) DEVICE AND METHOD WITH PROCESSING-IN-MEMORY

(71) Applicants: Samsung Electronics Co., Ltd., Suwon-si (KR); Research & Business Foundation SUNGKYUNKWAN UNIVERSITY, Suwon-si (KR)

(72) Inventors: Juhong PARK, Suwon-si (KR); Jong Hwan KO, Suwon-si (KR); Johnny RHE, Suwon-si (KR)

(73) Assignees: Samsung Electronics Co., Ltd., Suwon-si (KR); Research & Business Foundation SUNGKYUNKWAN UNIVERSITY, Suwon-si (KR)

(21) Appl. No.: 18/932,587

(22) Filed: Oct. 30, 2024

(30) Foreign Application Priority Data
Nov. 14, 2023 (KR) 10-2023-0157705
Jan. 19, 2024 (KR) 10-2024-0008936

(51) Int. Cl. G06F 7/501; G06F 5/01; G06F 7/505

(52) U.S. Cl. CPC G06F 7/501; G06F 5/01; G06F 7/5057

(57) ABSTRACT

A processing in memory (PIM) device includes a PIM array comprising a plurality of memory cells, a controller configured to determine a target mapping format from candidate mapping formats by a combination of load types of input data to the PIM array and mapping types of multi-bit of a neural network array with respect to the PIM array based on an operation condition, and generate a control signal for an operation based on the target mapping format, and an adaptive adder tree configured to perform a selective shift operation and an addition operation on an operation result of the PIM array based on the target mapping format.

### CROSS-REFERENCE TO RELATED APPLICATIONS

This application claims the benefit under 35 USC § 119(a) of Korean Patent Application No. 10-2023-0157705, filed on Nov. 14, 2023, and Korean Patent Application No. 10-2024-0008936, filed on Jan. 19, 2024, in the Korean Intellectual Property Office, the entire disclosures of which are incorporated herein by reference for all purposes.

### BACKGROUND

### 1. Field

The following description relates to a device and method with processing-in-memory (PIM).

### 2. Description of Related Art

A memory device may be functionally separated from a processor configured to perform an operation. A bottleneck may frequently occur as a large volume of data is transmitted and received between a memory device and a processor in a system, such as a neural network requiring an operation on a large volume of data, bit data, and Internet of Things (IoT). A memory device integrating a memory function with a function of a processor configured to perform an operation has been developed to solve the bottleneck.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processing in memory (PIM) device includes: a PIM array comprising a plurality of memory cells; a controller configured to: determine a target mapping format from candidate mapping formats by a combination of load types of input data to the PIM array and mapping types of multi-bit of a neural network array with respect to the PIM array based on an operation condition, and generate a control signal for an operation based on the target mapping format; and an adaptive adder tree configured to perform a selective shift operation and an addition operation on an operation result of the PIM array based on the target mapping format.

The adaptive adder tree may include, according to the control signal, for each stage of multiple stages, full adders (FAs) configured to perform the addition operation on data of odd-numbered rows of the PIM array, and a shifting logic configured to selectively perform the shift operation on data of even-numbered rows of the PIM array.

The controller may be configured to generate and transmit the control signal to perform the shift operation by the shifting logic before the addition operation is performed by the FAs in a stage of the multiple stages.

The shifting logic may reflect a weight of the multi-bit in even-numbered rows of the PIM array by the shift operation before the addition operation is performed by the FAs on each of the even-numbered rows of the PIM array based on the control signal.

The controller may be configured to determine computing cycles respectively corresponding to the candidate mapping formats, and, for the determining of the target mapping format, determine the target mapping format from the candidate mapping formats based on the computing cycles.

For the determining of the computing cycles, the controller may be configured to determine the computing cycles respectively corresponding to the candidate mapping formats based on a number of cycles (array row (AR) cycles) consumed to map multi-bit of the neural network array in a row direction of the PIM array, a number of cycles (array column (AC) cycles) consumed to map the multi-bit in a column direction of the PIM array, and a number of times of loading the input data through an input port.

The controller may include, for each of the candidate mapping formats, a look up table (LUT) comprising setting information on a shifting logic for performing the selective shift operation and a full adder (FA) for performing the addition operation, and, for the generating of the control signal, the controller may be configured to generate the control signal corresponding to the target mapping format by using the LUT.

The controller may be configured to receive information about the target mapping format determined based on the operation condition from a host device, and, for the generating of the control signal, generate the control signal to perform the operation based on the information about the target mapping format.

The operation condition may include any one or any combination of any two or more of layer information comprising any one or any combination of any two or more of a size of a layer of the neural network array, a depth of the layer, a number of input and output channels, a kernel size, and an image size, a size of the PIM array, and a number of multi-bits to be used for the operation.

The input data may include a kernel weight, and the PIM array may include an input feature map.

For the generating of the control signal, the controller may be configured to generate the control signal to split the multi-bit into various bit structures based on the target mapping format and map the multi-bit onto the PIM array.

The load types of the input data may include a first load type that loads the input data to an input port in series, and a second load type that loads the input data to the input port in parallel.

The mapping types may include a first mapping type that maps the multi-bit onto the PIM array for each row, a second mapping type that maps the multi-bit onto the PIM array for each column, and a third mapping type that splits and maps the multi-bit onto the PIM array.

In one or more general aspects, a method of operating a processing in memory (PIM) device includes receiving an operation condition, generating candidate mapping formats by a combination of load types of input data to a PIM array and mapping types of multi-bit of a neural network array with respect to the PIM array based on the operation condition, determining computing cycles respectively corresponding to the candidate mapping formats, determining a target mapping format from the candidate mapping formats based on the computing cycles, and
generating a control signal for an operation based on the target mapping format.

The determining of the computing cycles may include determining the computing cycles respectively corresponding to the candidate mapping formats based on a number of cycles (array row (AR) cycles) consumed to map multi-bit of the neural network array in a row direction of the PIM array, a number of cycles (array column (AC) cycles) consumed to map the multi-bit in a column direction of the PIM array, and a number of times of loading the input data through an input port.

The generating of the control signal may include, for each of the candidate mapping formats, generating the control signal to support a mapping type of the PIM array corresponding to the target mapping format and a load type of the input data by using a look up table (LUT) comprising setting information on a shifting logic for performing a selective shift operation and a full adder (FA) for performing an addition operation.

The generating of the control signal may include generating a control signal to perform a selective shift operation and an addition operation on an operation result of the PIM array based on the target mapping format.

The generating of the control signal further may include generating and transmitting the control signal to perform the shift operation by a shifting logic before the addition operation is performed by FAs in a stage of multiple stages.

The generating of the control signal may include generating the control signal to split the multi-bit into various bit structures based on the target mapping format and map the multi-bit onto the PIM array.

The operation condition may include any one or any combination of any two or more of layer information comprising any one or any combination of any two or more of a size of a layer of the neural network array, a depth of the layer, a number of input and output channels, a kernel size, and an image size, a size of the PIM array, and a number of multi-bits to be used for the operation.

Other features and aspects will be apparent from the following detailed description, the drawings, and the claims.

### BRIEF DESCRIPTION OF THE DRAWINGS

FIG. 1 is a block diagram of a processing in memory (PIM) device according to one or more embodiments.

FIG. 2A illustrates a first mapping type and a second mapping type of multi-bit mapping types in a PIM array according to one or more embodiments.

FIG. 2B illustrates a third mapping type of multi-bit mapping types in a PIM array according to one or more embodiments.

FIG. 3 illustrates candidate mapping formats by a combination of load types of input data and multi-bit mapping types according to one or more embodiments.

FIG. 4A illustrates a structure and an operation of an adaptive adder tree in a PIM device according to one or more embodiments.

FIG. 4B illustrates a shifting logic of an adaptive adder tree and an operation of a full adder according to one or more embodiments.

FIGS. 5A and 5B illustrate an operating principle of an adaptive adder tree based on a target mapping format according to one or more embodiments.

FIG. 6 illustrates a structure and an operation of a PIM device according to one or more embodiments.

FIG. 7 is a flowchart illustrating an operation method of a controller of a PIM device according to one or more embodiments.

FIGS. 8A, 8B, and 8C illustrate a method of calculating a computing cycle based on a target mapping format according to one or more embodiments.

FIG. 9 is a flowchart illustrating an operation method of a PIM device according to one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and based on an understanding of the disclosure of the present application. It will be further understood that terms, such as those defined in commonly used dictionaries, should be interpreted as having a meaning that is consistent with their meaning in the context of the relevant art and the disclosure of the present application, and will not be interpreted in an idealized or overly formal sense unless expressly so defined herein.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Embodiments to be described below may be applied to a neural network, a processor, a smartphone, a mobile device, and the like performing an artificial intelligence (AI) operation and/or high performance-computing (HPC) processing. In addition, the following embodiments can be applied in various fields where low-power and high-efficiency computation based on PIM (Processing In Memory) is possible, and in particular, they can be applied to technologies such as keyword spotting and always-on display, which mainly use depth-wise convolutional layers.

Hereinafter, the embodiments will be described in detail with reference to the accompanying drawings. When describing the embodiments with reference to the accompanying drawings, like reference numerals refer to like elements and a repeated description related thereto will be omitted.

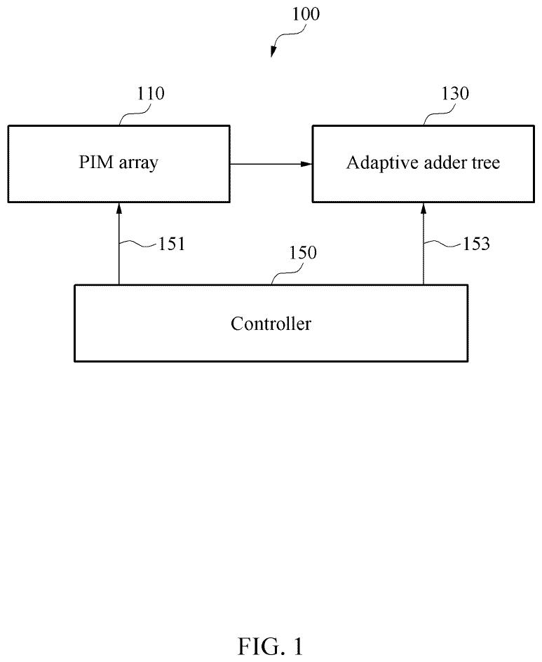

FIG. 1 is a block diagram of a processing in memory (PIM) device according to one or more embodiments. Referring to FIG. 1, a PIM device 100 in one or more embodiments may include a PIM array 110, an adaptive adder tree 130, and a controller 150.

The PIM device 100 may correspond to a digital-based PIM device. The PIM device 100 may be, for example, dynamic random access memory (DRAM), such as double data rate synchronous DRAM (DDR SDRAM), low power DDR (LPDDR) SDRAM, graphics DDR (GDDR) SDRAM, and Rambus DRAM (RDRAM), but the example is not limited thereto. The PIM device 100 may be implemented by non-volatile memory, such as flash memory, magnetic RAM (MRAM), ferroelectric RAM (FeRAM), phase change RAM (PRAM), and resistive RAM (ReRAM). In addition, the PIM device 100 may correspond to one semiconductor chip or may be a configuration corresponding to one channel in a memory device including multiple channels having an independent interface. The PIM device 100 may be a configuration corresponding to a memory module and the memory module may include multiple memory chips. Various types of computational processing operations may be performed by the PIM device 100, for example, at least a portion of operations of a neural network model related to Al may be performed by the PIM device 100. For example, a host device may control the PIM device 100 to perform at least a portion of the operations of a neural network through the controller 150.

The PIM array 110 may correspond to an SRAM memory array including a plurality of memory cells. The plurality of memory cells may correspond to, for example, SRAM bit cells. The plurality of memory cells may configure one or multiple memory banks.

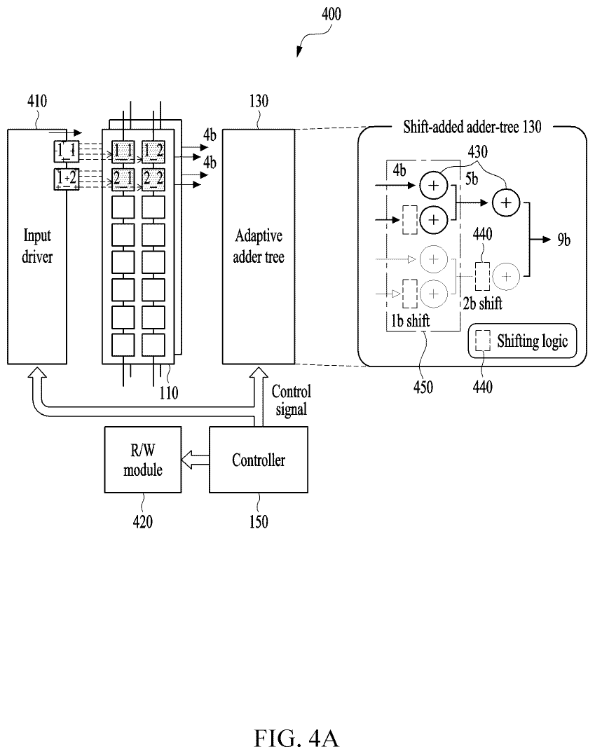

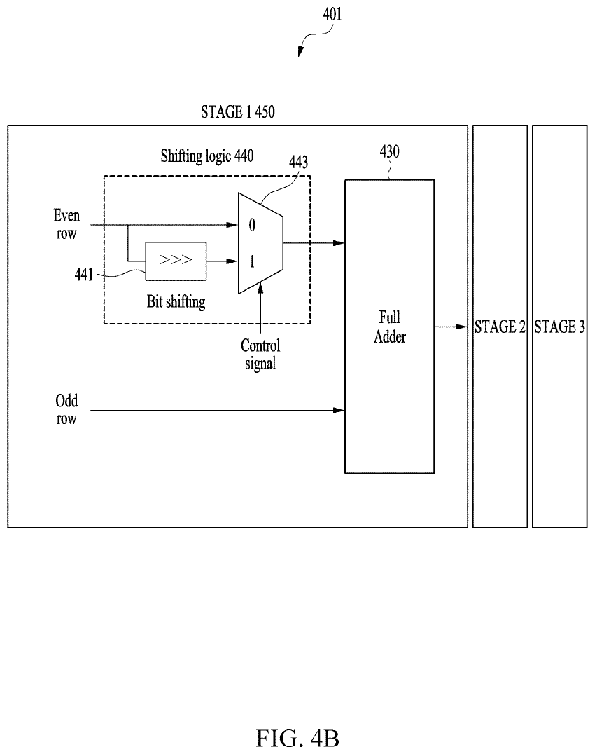

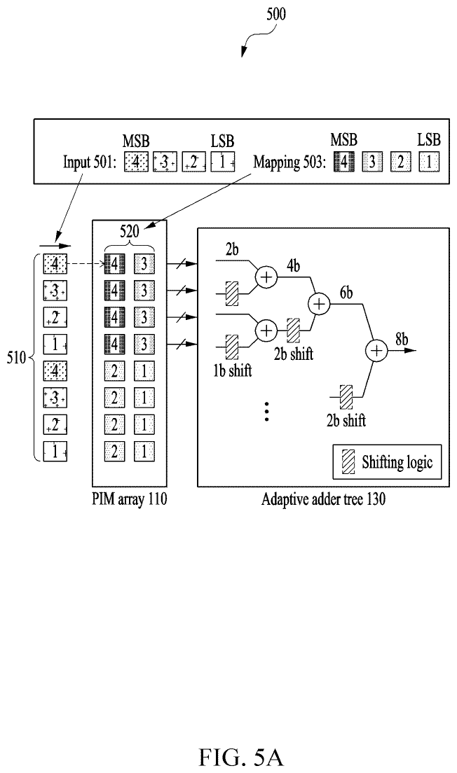

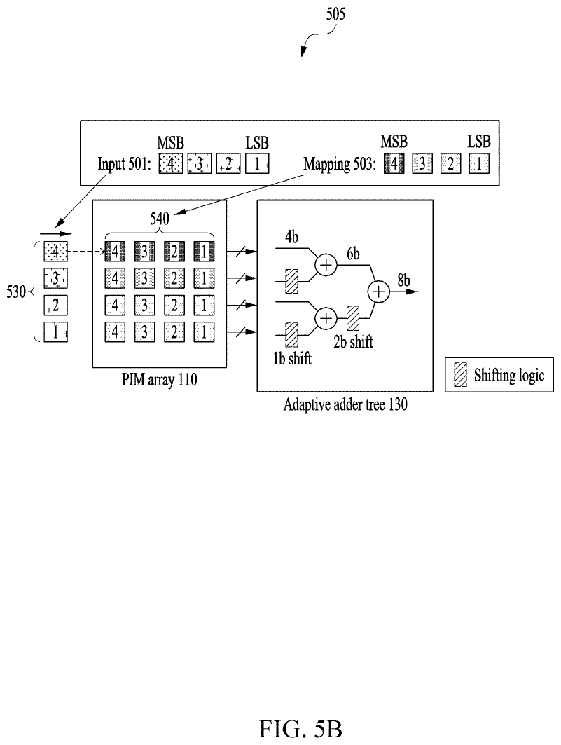

The adaptive adder tree 130 may perform an addition operation and/or a shift operation based on a control signal 153 generated by the controller 150. The adaptive adder tree 130 may perform a selective shift operation and an addition operation on an operation result of the PIM array 110 based on a target mapping format determined by the controller 150. The adaptive adder tree 130 may include full adders (FAs) performing an addition operation on data of odd-numbered rows of the PIM array 110 and a shifting logic selectively performing a shift operation on data of even-numbered rows of the PIM array 110 for each stage of multiple stages. For example, the shift operation may correspond to bit shifting. Examples of a structure and an operation of the adaptive adder tree 130 are further described with reference to FIGS. 4A to 5B below.

The controller 150 may determine a target mapping format from candidate mapping formats by a combination of load types of input data to the PIM array 110 and multi-bit mapping types with respect to the PIM array 110 based on an operation condition and may generate a control signal 151 for an operation based on the target mapping format.

The load types of input data may include, for example, a first load type that sequentially applies input data to the PIM array 110 by one or two bits in series and a second load type that applies input data to the PIM array 110 by four or eight bits in parallel at once. In addition, the mapping types may include at least one of a first mapping type that maps multi-bit onto the PIM array 110 by row, a second mapping type that maps multi-bit onto the PIM array 110 by column, and a third mapping type that splits and maps multi-bit onto the PIM array 110.

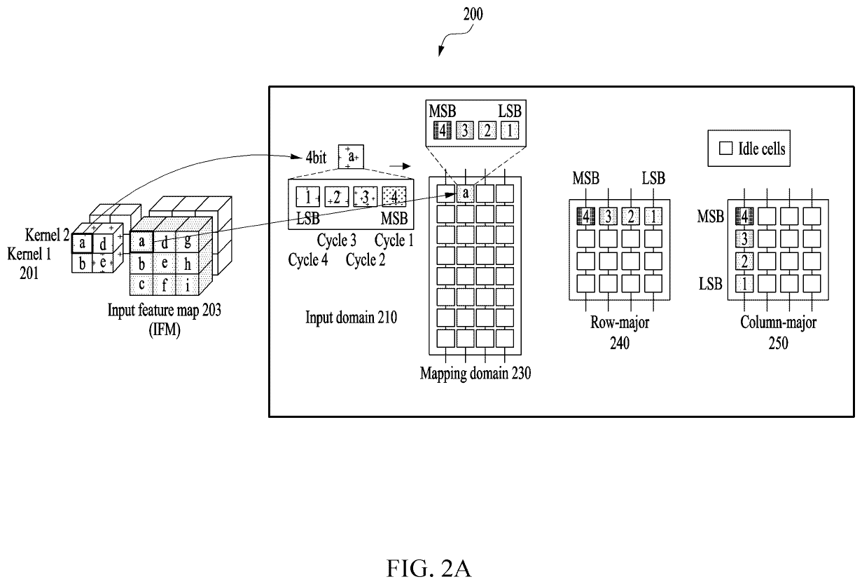

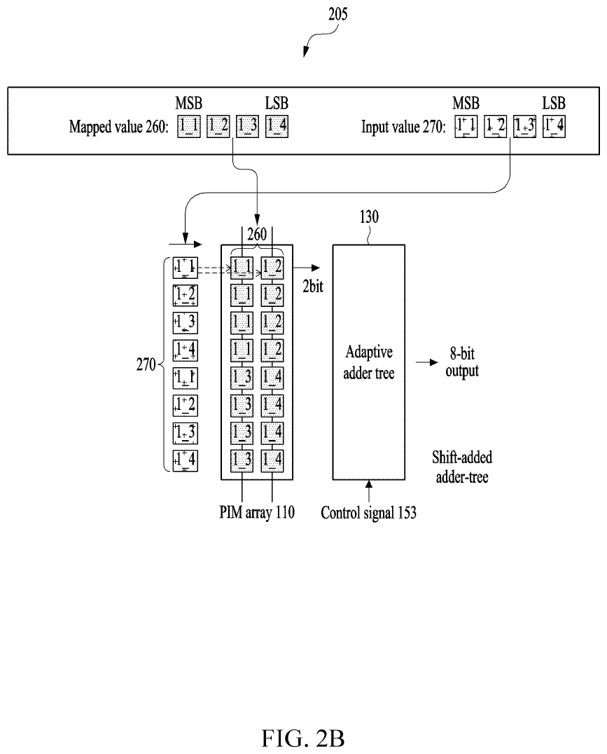

An example of a method of representing multi-bit based on the mapping types in the PIM array 110 is further described with reference to FIGS. 2A and 2B below.

For example, the input data may include a kernel weight and the PIM array 110 may include an input feature map (IFM), but the example is not limited thereto. As another example, the input data may include an IFM and the PIM array 110 may include a kernel weight.

In this example, the multi-bit may correspond to multi-bit of a neural network array and the neural network array may include, for example, a depth-wise convolutional layer. However, the example is not limited thereto.

The operation condition may include at least one of layer information, a size of the PIM array 110, and the number of multi-bits to be used for the operation. The layer information may include, for example, a size of a layer of the neural network array, a depth of a layer, the number of input and output channels, a kernel size, and/or an image size, but the example is not limited thereto.

The controller 150 may further include a lookup table (LUT) including setting information on a shifting logic for performing a selective shift operation and an FA performing an addition operation for each candidate mapping format. The LUT may include setting information about which shifting logic performs a 1-bit shift or 2-bit shift operation on each stage of multiple stages and which FA performs an addition operation.

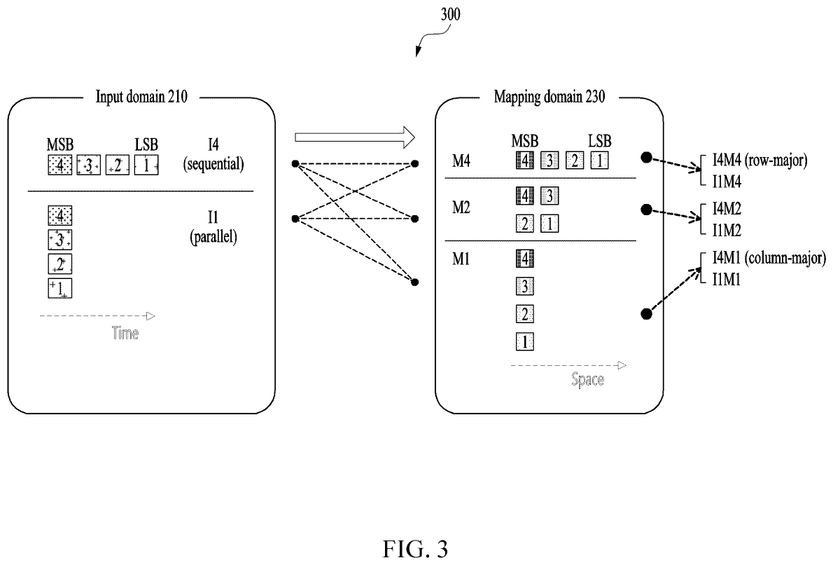

The controller 150 may generate a control signal corresponding to the target mapping format using the LUT. An example of the candidate mapping formats by a combination of the load types of the input data and the mapping types of the multi-bit is further described with reference to FIG. 3.

The controller 150 may generate a control signal for mapping the multi-bit onto the PIM array 110 by splitting the multi-bit into various bit structures based on the target mapping format.

The controller 150 may generate the control signal 153 to perform a shift operation by a shifting logic before an addition operation is performed by FAs in a stage of multiple stages and may transmit the control signal 153 to each module (e.g., the PIM array 110 and the adaptive adder tree 130) of the PIM device 100. For example, the controller 150 may control (e.g., cause) three stages (e.g., a stage 1, a stage 2, and a stage 3) to reflect a weight of the multi-bit through a shift operation before an addition operation to support mapping onto the PIM array 110 based on the target mapping format. The controller 150 may independently transmit a control signal to each stage of the adaptive adder tree 130 to control the adaptive adder tree 130 to selectively perform 0-bit, 1-bit, and 2-bit shift operations before an FA performs an addition operation.

The controller 150 may calculate (e.g., determine) computing cycles corresponding to the candidate mapping formats, respectively. The controller 150 may determine the target mapping format from the candidate mapping formats based on the computing cycle. The controller 150 may determine one of computing cycles of the candidate mapping formats that has a minimum computing cycle to be the target mapping format.

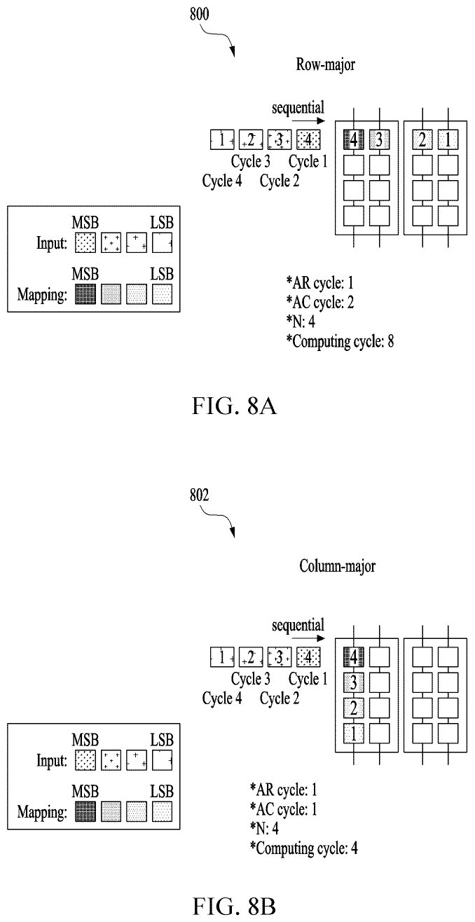

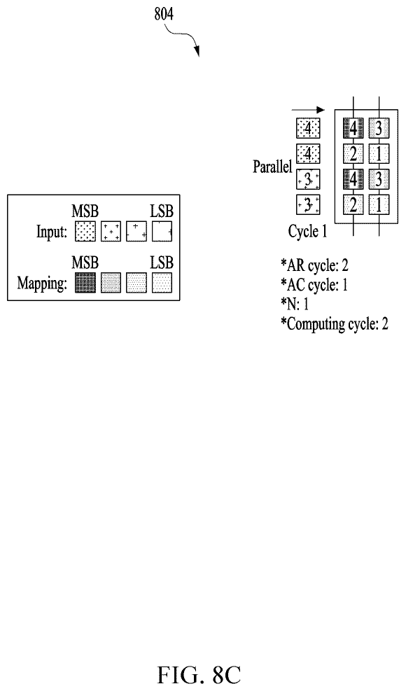

The controller 150 may, for example, calculate computing cycles corresponding to the candidate mapping formats, respectively, based on the number N of cycles (AR cycles) consumed to map multi-bit in a row direction of the PIM array 110, the number of cycles (AC cycles) consumed to map multi-bit in a column direction of the PIM array 110, and the number of times in which the input data is loaded through an input port. An example of a method of the controller 150 to calculate a computing cycle based on the candidate mapping formats is further described with reference to FIGS. 8A, 8B, and 8C below.

Depending on the embodiment, the controller 150 may receive information about the target mapping format determined based on an operation condition in a host device. The controller 150 may generate a control signal for performing an operation based on information about the target mapping format. In this example, the control signal may correspond to, for example, a control signal configured to load input data to an input port on a column-major basis.

FIG. 2A illustrates a first mapping type and a second mapping type of multi-bit mapping types in a PIM array according to one or more embodiments. Referring to FIG. 2A, in a diagram 200, a diagram 240 illustrating an input domain 210 to which a weight kernel 201 is applied and a first mapping type in which multi-bit are mapped onto a PIM array by row in a mapping domain 230 of a PIM array onto which an IFM 203 is mapped and a diagram 250 illustrating a second mapping type in which multi-bit are mapped onto a PIM array by column are illustrated.

Since a value (e.g., the weight kernel 201) loaded to the input domain 210 of the input port may be reused in the PIM array, the PIM device of one or more embodiments may decrease a computing cycle of a typical convolutional layer in which multiple weight kernels reuse the IFM 203 (or a weight).

The PIM device may perform a matrix-vector multiplication operation between the IFM 203 and the weight kernel 201 of the same row using a circuit characteristic of Ohm's law of the memory cells of the PIM array.

For multi-bit scalability, accuracy and operation efficiency may have an inverse relationship and the PIM device of one or more embodiments may enable multi-bit scaling in two domains of the input domain 210 and the mapping domain 230 of the PIM device.

The PIM device may use an IFM-based mapping method in which a three-dimensional IFM 203 is spread in one dimension and mapped onto each column of the mapping domain 230. A one-dimensional weight kernel 201 spread in the IFM-based mapping method may enter the input domain 210 of the input port and may be used to perform a matrix-vector multiplication operation with the IFM 203. The IFM-based mapping method may be used to reuse the weight kernel 201 applied to the input domain 210 of the input port.

As described above, the method of mapping the IFM 203 may be an appropriate mapping method to a depth-wise convolutional layer. In the depth-wise convolution, the weight kernel 201 may be reused by sliding the weight kernel 201 over the IFM 203. Thus, the PIM device may load a value of the kernel weight 201 to the input domain 210 of the input port of the PIM array and may reuse the weight kernel 201 through a method of mapping the weight kernel 201 and the IFM 203 that performs a convolution operation onto each column of the mapping domain 230 of the PIM array.

In the mapping domain 230, multi-bit may be represented in a row-major manner as in the diagram 240 or the multi-bit may be represented in a column-major manner as in the diagram 250.

The first mapping type of row-major may be a method of mapping multi-bit onto a PIM array in a PIM-based convolution operation. The row-major mapping method may map multi-bit, which represents a single value, onto the same row as shown in the diagram 240 in the mapping domain 230 of the PIM array in a row direction from a most significant bit (MSB) to a least significant bit (LSB).

On the other hand, the second mapping type of column-major may be a method of mapping multi-bit representing a single value in a column direction of an array. The column-major mapping method may map multi-bit representing a single value onto the same column as shown in the diagram 250 in the mapping domain 230 of the PIM array from the MSB to the LSB in the column direction.

FIG. 2B illustrates a third mapping type of multi-bit mapping types in a PIM array according to one or more embodiments. Referring to FIG. 2B, as the third mapping type according to one or more embodiments, a diagram 205 illustrating a 4-bit mapping value 260 (e.g., a weight kernel) mapped onto the PIM array 110 and a 4-bit input value 270 (e.g., an IFM) is illustrated. The third mapping type may be a column-major mapping method based on a multi-bit division method.

For example, a digital-based PIM device in one or more embodiments may use a column-major method loading input data to an input port in a column-major manner while simultaneously using a multi-bit splitting method of splitting multi-bit into various bit structures to efficiently map a depth-wise convolutional layer onto the PIM array 110.

In one or more embodiments, a method of mapping the IFM 270 that reuses the weight kernel 260 may be used for an effective operation of a depth-wise layer. The PIM device of one or more embodiments may map the IFM 270 onto the PIM array 110 while simultaneously increasing the utilization of the PIM array 110 in the row direction by using the column-major mapping method. In this example, when using the column-major mapping method, since the structure of multi-bit is not changed by considering the size of the neural network and the PIM array 110, a typical PIM device may not maximize the array utilization. In an embodiment, the PIM device of one or more embodiments may increase the low array utilization that occurs when mapping the IFM 270 by multi-bit splitting that may split into various bit structures and an improved column-major mapping method that inputs the weight kernel 260 into the input port in a column-major manner.

In addition, the PIM device of one or more embodiments may improve the efficiency of the energy consumed for an operation and inference latency by decreasing the number of input times and a computing cycle by using the adaptive adder tree 130 that is controllable and is configured to efficiently support an operation required for an input and various mapping types in which multi-bit is split.

FIG. 3 illustrates candidate mapping formats by a combination of load types of input data and multi-bit mapping types according to one or more embodiments. Referring to FIG. 3, a diagram 300 illustrates candidate mapping formats having various inputs generated by 4-bit of multi-bit and mapping forms according to multi-bit splitting according to one or more embodiments.

### Multi-Bit Splitting

In one or more embodiments, to increase the array utilization of a depth-wise convolutional layer, the PIM device of one or more embodiments may maximize the utilization of an array by adopting multi-bit splitting (BS) and using an improved column-major mapping method in which a value (e.g., a weight kernel) applied to the input domain 210 is mapped onto the mapping domain 230 in a column-major manner while inputting in parallel.

The BS may be a method of splitting bits depending on a given circumstance and arranging the bits in a PIM array rather than arranging a multi-bit value from an MSB to an LSB in the same row or column.

A condition of the given circumstance (“an operation condition”) may include, for example, layer information including a size of the PIM array and a size of a neural network to be mapped and the number of bits to be mapped.

In this example, the “layer information” may include, for example, the size of a layer of the neural network, the depth of the layer, the number of input and output channels, the kernel size, and/or the image size. In addition, the “number of bits to be mapped” may correspond to the number of multi-bits used for an operation.

In the BS, to secure the regularity of an adaptive adder tree, for example, when the multi-bit is ⁿ-bit, the multi-bit may be accumulated and split in the form of n/2, and through this, (log₂n)+1 mapping types may be determined.

For example, as shown in FIG. 3, when the multi-bit is 4-bits, a mapping type in which 4-bits are arranged in the same row, a mapping type in which the multi-bit is split into 2-bits (which are one half of 4-bits) and arranged in each row of a memory, and a mapping type in which the multi-bit is split into 1-bit (which is one half of 2-bits) and arranged in each row of the memory may be determined. In other words, in the case of 4-bit mapping, three mapping types of a value of (log₂ 4)+1 may exist.

Load types of input data to the input domain 210 of the input port may include, for example, two types, which are a first load type in which input data is applied to the input port in series (e.g., sequentially) and a second load type in which input data is applied to the input port in parallel. In this example, the first load type in which multi-bit of 4-bits is applied to the PIM array in series, in other words, multi-bit of 4-bits is sequentially applied to the PIM array one by one for four times may be expressed as “I4”. In addition, the second load type in which multi-bit of 4-bits applies to the PIM array at once in parallel (e.g., simultaneously) may be expressed as “I1”. Among the load types of the input data to the input domain 210, the second load type may reduce a computing cycle due to the access to an external memory.

For example, mapping onto the mapping domain 230 of the PIM array may reduce the computing cycle by changing multi-bit of n-bits to flexible multi-bit in the form of log₂n by multi-bit splitting described below. For example, when the multi-bit is 4-bits, mapping onto the mapping domain 230 of the PIM array may change to, for example, three types, which are M4: (1×4), M2: (2×2), M1: (4×1).

As described above, when the multi-bit is 4-bits, a total of six candidate mapping formats, which are I4M4 (row-major), I1M4, I4M2, 1M2, 4M1 (column-major), and I1M1, may be generated by a combination of two load types (e.g., 14 and 11) of the input data and three mapping types (e.g., M4, M2, and M1).

FIG. 4A illustrates a structure and an operation of an adaptive adder tree in a PIM device according to one or more embodiments. Referring to FIG. 4A, a structure of a PIM device 400 including the adaptive adder tree 130 according to one or more embodiments is illustrated.

In one or more embodiments, the adaptive adder tree 130 that is configured to compute a weight of another bit may be used depending on a case to support multi-bit splitting based on a given operation condition. Whereas a typical adder tree may process only a bit in a fixed form of a predetermined row or column, the adaptive adder tree 130 of one or more embodiments may perform an operation by considering various bit weights through the adaptive adder tree 130 to which a shifting logic 440 is added.

The PIM device 400 of one or more embodiments may decrease the inference latency while improving the energy efficiency by decreasing a computing cycle and the number of input times by performing an addition operation on a row-major mapping type, a column-major mapping type, and a multi-bit splitting mapping type using a method of manipulating the shifting logic 440 through a control signal of the controller 150 generated by a given algorithm.

The PIM device 400 may include, for example, the PIM array 110, the adaptive adder tree 130, the controller 150, an input driver 410, and a read and write (R/W) module 420.

The controller 150 may perform two-step processing. Firstly, the controller 150 may calculate computing cycles respectively corresponding to various candidate mapping formats according to the row-major mapping type, the column-major mapping type, and the multi-bit splitting mapping type based on the mapping of an IFM. In this example, the controller 150 may calculate a computing cycle by considering a network size of a given artificial neural network, the size of a PIM array, and the number of bits to be calculated.

In addition, the controller 150 may determine a target mapping format having a minimum computing cycle among the computing cycles respectively corresponding to the candidate mapping formats. The controller 150 may generate a control signal allowing other modules (e.g., the PIM array 110, the adaptive adder tree 130, the input driver 410, and the R/W module 420) of the PIM device 400 to support the target mapping format.

The adaptive adder tree 130 may, for example, perform an addition operation for a convolutional layer represented by matrix-vector multiplication. Whereas a typical adder tree may process only a bit structure having a fixed form in a predefined row or column-major manner, in the adaptive adder tree 130 of one or more embodiments, the controller 150 may change the structure of multi-bit depending on an operation condition, may map the multi-bit onto the PIM array 110, and may perform an operation on various applied inputs.

The adaptive adder tree 130 may perform an addition operation on the candidate mapping formats based on a combination of various mapping types in which multi-bit is split by FAs 430 and shifting logics 440 included for each stage of multiple stages and load types of input data. An example of an operation of the adaptive adder tree 130 is further described with reference to FIG. 4B below.

The input driver 410 and the R/W module 420 may perform a task supporting various mapping formats according to a control signal of the controller 150.

The input driver 410 may load input data based on a load type of the input data according to the control signal. The R/W module 420 may map multi-bit onto the PIM array 110 based on various mapping types of split multi-bit according to the control signal.

FIG. 4B illustrates a shifting logic of an adaptive adder tree and an operation of a full adder according to one or more embodiments. Referring to FIG. 4B, a diagram 401 illustrating the adaptive adder tree 130 including the FA 430 and the shifting logic 440 for each stage of multiple stages according to one or more embodiments is illustrated.

The diagram 401 may show an operation of the adaptive adder tree 130 corresponding to a stage 1 450 of multiple stages. In this example, the “stage” may refer to each operation stage of the adaptive adder tree 130. The adaptive adder tree 130 may be constituted by the FA 430 having multiple stages.

When the FA 430 having multiple stages receives a control signal from the controller 150, the FA 430 may perform an addition operation after shifting an output before an addition process for each even-numbered column of the PIM array 110. This may correspond to a result in which the adaptive adder tree 130 splits multi-bit into (log₂n)+1 when mapping for an operation of the multi-bit of n-bits and considers a weight of each position of the bits.

Accordingly, for example, the shifting logic 440 may perform a shift operation in the form of 0-bit, 1-bit, and 2-bits as shown in Table 1 below, for example, according to the control signal for each mapping type.

TABLE 1

| Signal | Shifting |
|---|---|
| 0 | 0 bit |
| 1 | 1 bit/2 bits |
| | (Depending on STAGE No.) |

The control signal for a 0-bit shift operation may perform the shifting logic 440 of each stage. The adaptive adder tree 130 may also perform an addition operation by a typical adder tree through a control signal for the 0-bit shift operation.

The shifting logic 440 may include, for example, a shifter 441 configured to perform bit shifting on each even-numbered row of the PIM array and a multiplexer (MUX) 443 configured to selectively use a shift operation result performed by the shifter 441 according to the control signal.

The controller 150 may generate and transmit a control signal to perform a shift operation by the shifting logic 440 before an addition operation is performed by the FA 430 in the multiple stages. To support mapping onto the PIM array 110 based on the target mapping format, the controller 150 may, for example, control each of the three stages (e.g., stages 1, 2, and 3) to reflect a weight of multi-bit through the shift operation before the addition operation. The controller 150 may independently transmit a control signal to each stage of the adaptive adder tree 130 to control the adaptive adder tree 130 to selectively perform 0-bit, 1-bit, and 2-bit shift operations by the shifting logic 440 before the FA 430 performs an addition operation.

The shifting logic 440 may reflect the weight of multi-bit in even-numbered rows of the PIM array 110 by the shift operation of the shifting logic 440 before the FA 430 performs the addition operation on each of the even-numbered rows of the PIM array according to the control signal.

The controller 150 may generate and transmit a control signal for each of the FAs 430 and the shifting logic 440 in the multiple stages.

The adaptive adder tree 130 may cover various mapping formats through an addition operation for each of the even-numbered rows of the PIM array and a selective shift operation for data of the even-numbered rows of the PIM array 110.

FIGS. 5A and 5B illustrate an operating principle of an adaptive adder tree based on a target mapping format according to one or more embodiments.

Referring to FIG. 5A, a diagram 500 showing an operation process of an adaptive adder tree when a target mapping format is I1M2 of 4-bits according to one or more embodiments is illustrated.

As described above, the adaptive adder tree 130 may perform an addition operation in the form of a flexible multi-bit and a shifting logic may selectively perform a shifting operation on each of the even-numbered rows of a PIM array based on a control signal.

For example, when the target mapping format is I1M2 of 4-bits, according to “I1”, the controller may generate a control signal for controlling an input driver to load input data 501 of 4-bits to an input port in parallel as shown in a diagram 510 according to the second load type.

In addition, according to “M2”, the controller may generate a control signal for controlling the PIM array 110 to map mapping data 503 of 4-bits by splitting the mapping data 503 into 2-bits as shown in a diagram 520.

For the adaptive adder tree 130, the controller may generate a control signal to perform, for example, a 1-bit shift operation in the stage 1 and perform a 2-bit shift operation in the stages 2 and 3.

Referring to FIG. 5B, a diagram 505 showing an operation process of an adaptive adder tree when a target mapping format is I1M4 of 4-bits according to one or more embodiments is illustrated.

As described above, the adaptive adder tree 130 may perform an addition operation in the form of a flexible multi-bit and a shifting logic may selectively perform a shifting operation on each of the even-numbered rows of a PIM array based on a control signal.

For example, when the target mapping format is I1M2 of 4-bits, according to “I1”, the controller may generate a control signal for controlling an input driver to load input data 501 of 4-bits to an input port in parallel as shown in a diagram 530 according to the second load type.

In addition, according to “M4”, the controller may generate a control signal for controlling the PIM array 110 to map mapping data 503 of 4-bits by splitting the mapping data 503 into 1-bit as shown in a diagram 540.

For the adaptive adder tree 130, the controller may generate a control signal to perform, for example, a 1-bit shift operation in the stage 1 and perform a 2-bit shift operation in the stage 2.

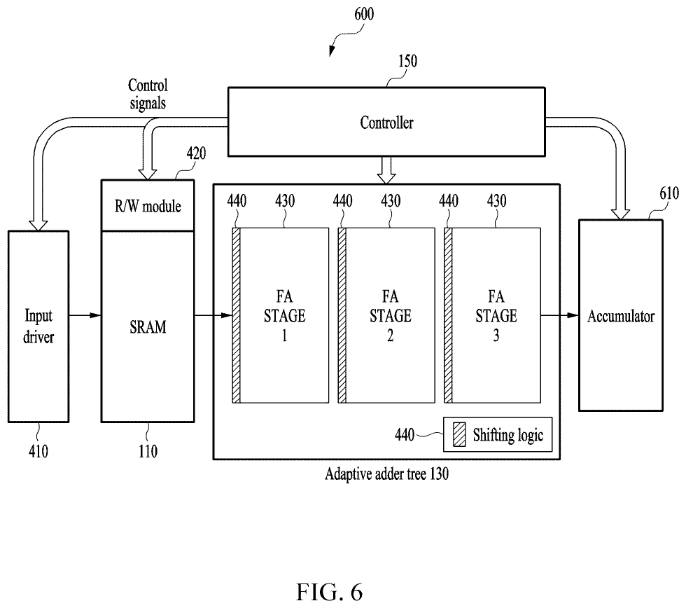

FIG. 6 illustrates a structure and an operation of a PIM device according to one or more embodiments. Referring to FIG. 6, a diagram 600 showing an overall configuration of a PIM device and a signal flow of the controller 150 according to one or more embodiments is illustrated.

The controller 150 may calculate computing cycles of the candidate mapping formats and may select a mapping format (e.g., the target mapping format) having a minimum computing cycle from the calculated computing cycles. The controller 150 may generate a control signal allowing each module (e.g., the PIM array 110, the adaptive adder tree 130, the input driver 410, the R/W module 420, and an accumulator 610) of the PIM device to support the selected target mapping format.

The PIM device may change a mapping type of multi-bit to the PIM array 110 and a load type of input data based on the target mapping format selected by the controller 150.

In this example, the controller 150 may generate and propagate a control signal allowing each module of the PIM device to process the changed mapping type of multi-bit and the load type of input data according to the target mapping format.

The controller 150 may, for example, calculate a computing cycle for various mapping formats by Equation 1 described below, for example, when an operation condition is given.

For example, an example in which a depth-wise convolution operation is performed with a 28×28×128 (image×input channel)-sized image and a 3×3-sized kernel weight, and a stride of “1” may be provided. In this example, the number of bits to be used for an operation may be 4 for an IFM and the kernel weight and the size of the PIM array 110 to be used may be 96×96.

When mapping an IFM of 4-bits onto all rows at once in parallel according to the given operation condition, the controller 150 may calculate a computing cycle as AR cycle (1)×AC cycle (29)×number of times to input (128×1)=3,712 by considering an input of multi-bit and a mapped form.

Similarly, when mapping an IFM of 4-bits by splitting the IFM into 2-bits, the controller 150 may calculate the computing cycle as

AR cycle (1)×AC cycle (15)×number of times to input (128×1)=1,920

In addition, when mapping an IFM of 4-bits by splitting the IFM into 1-bit, the controller 150 may calculate the computing cycle as

AR cycle (2)×AC cycle (8)×number of times to input (128×1)=2,048.

The controller 150 may select a mapping type in the form of 2-bits corresponding to the minimum computing cycle among the previously calculated computing cycles to be the target mapping format and may generate a control signal required for each module of the PIM device to support the mapping type in the form of 2-bits by referring to an LUT.

To support the target mapping format, the adaptive adder tree 130 may, for example, reflect a weight of multi-bit in an addition operation result by performing a shift operation by the shifting logic 440 before performing an addition operation by the FAs 430 in each of three stages of stage 1, stage 2, stage 3.

The controller 150 may control the shifting logic 440 of each stage to perform a 1-bit shift operation, a 2-bit shift operation, and a 2-bit shift operation before an addition operation of the FAs 430 by independently transmitting a control signal to each stage of the adaptive adder tree 130.

The controller 150 may generate and transmit a control signal to control the accumulator 610 to perform and output an accumulate operation on an operation result of the adaptive adder tree 130.

In addition, the controller 150 may generate and transmit a control signal controlling the input driver 410 to load input data based on a load type of the input data according to an improved column-major mapping method. The controller 150 may control the R/W module 420 to map the multi-bit based on the mapping type and load the input data by generating and transmitting a control signal to control the R/W module 420 to perform 2-bit mapping onto the PIM array 110.

As described above, the PIM device of one or more embodiments may decrease the consumed energy and operation time by performing an operation with a minimum computing cycle by selecting an optimal mapping type for a depth-wise convolutional layer by considering various operation conditions (e.g., the size of the convolutional layer, the number of multi-bits to be used, and the size of the PIM array).

For example, the PIM device may determine the optimal mapping format that configures the PIM device to compute the depth-wise convolutional layer with the minimum computing cycle by mapping the multi-bit by multi-bit splitting and loading input data to an input port using the improved column-major method for spreading the multi-bit in the column-major manner.

The PIM device may reduce a computing cycle and may decrease the consumed energy and time through a strategy that maps values controlling an additional cycle onto idle memory cells or inactive memory cells by using multi-bit splitting.

In addition, the PIM device of one or more embodiments may minimize the access to an external memory by filling input data of a following sequence and a value to be computed in the idle memory cells or inactive memory cells in the PIM array by using the improved column-major method. The PIM device of one or more embodiments may reduce the energy involved in the access to the external memory and time by reducing the number of accesses to the external memory.

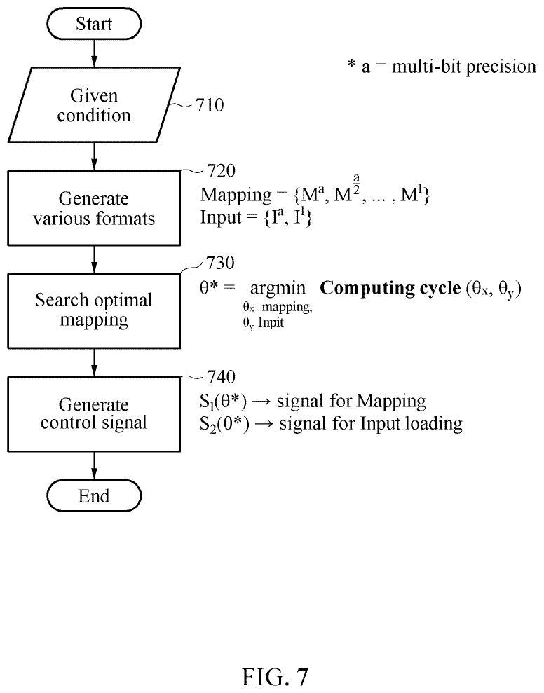

FIG. 7 is a flowchart illustrating an operation method of a controller of a PIM device according to one or more embodiments. Operations 710 to 740 described below may be performed in the order and manner as shown and described below with reference to FIG. 7, but the order of one or more of the operations may be changed, one or more of the operations may be omitted, and/or two or more of the operations may be performed in parallel or simultaneously without departing from the spirit and scope of the example embodiments described herein. Referring to FIG. 7, the controller of the PIM device may generate a control signal through operations 710 to 740 according to one or more embodiments.

In operation 710, the controller may receive a given condition. The given condition may include, for example, a size of a PIM array, a size of a layer, and the number of multi-bits (multi-bit precision) to be used for an operation. However, the example is not limited thereto. The given condition may correspond to the operation condition described above.

In operation 720, the controller may generate various candidate mapping formats by a combination of

$$Mapping = \{ {M}^{a} , {M}^{\frac{a}{2}} , … , {M}^{1} \}$$

and Input={I^{α}, I1} (in this example, a may correspond to the number of multi-bits (multi-bit precision) to be used for the operation) in a mapping domain and an input domain based on the given condition. The candidate mapping formats may be, for example, I4M4 (row-major), I1M4, I4M2, I1M2, I4M1 (column-major), and I1M1. However, the example is not limited thereto.

In operation 730, the controller may find a target mapping format having an optimal computing cycle (e.g., a minimum computing cycle) from the candidate mapping formats generated in operation 720. The controller may find, for example, a target mapping format θ* having the minimum computing cycle as

$${θ}^{*} = {{arg min}_{{θ}_{x} ∈ Mapping ,}}_{{θ}_{y} ∈ Input} Computing cycle ( {θ}_{x} , {θ}_{y} ) .$$

In operation 740, the controller may generate a control signal that supports the target mapping format found in operation 730. In this example, the controller may generate, for example, a control signal S₁(θ*)→signal for Mapping for controlling a mapping type of multi-bit with respect to the PIM array and a control signal S₂(θ*)→signal for Input loading for controlling a load type of an input data to an input port. For example, the controller may generate a control signal using an LUT.

FIGS. 8A, 8B, and 8C illustrate a method of calculating a computing cycle based on a target mapping format according to one or more embodiments.

Referring to FIG. 8A, a diagram 800 showing a result of calculating a computing cycle when a PIM array is mapped in a row-major manner according to one or more embodiments is illustrated.

The PIM device may, for example, calculate computing cycles corresponding to mapping types as Equation 1 shown below, for example.

$$Computing cycle = N \times AR cycle \times AC cycle \qquad Equation 1$$

In this example, N may denote the number of times of loading input data through an input port. An AR cycle may correspond to the number of arrays required for mapping in the row direction of the PIM array, in other words, the number of cycles consumed to map a layer of a neural network in the row direction of the PIM array 110. In addition, an AC cycle may correspond to the number of arrays required for mapping in the column direction of the PIM array, in other words, the number of cycles consumed to map a layer of a neural network in the column direction of the PIM array 110.

To summarize, the computing cycle may be defined by a product of the number of arrays required for mapping with respect to the same input and the number of input times.

For example, as shown in the diagram 800, when mapping the input data onto the PIM array sequentially (14) in row-major, the number of cycles (AR cycles) consumed to map multi-bit of 4-bits onto the PIM array 110 in the row direction may be “1” and the number of cycles (AC cycles) consumed to map the multi-bit in the column direction of the PIM array 110 may be “2”. In this example, the number of times of loading the input data of 4-bits through the input port may be “4”.

Accordingly, as shown in the diagram 800, the computing cycle when the PIM array is mapped in the row-major manner may be calculated as 4×1×2=8.

Referring to FIG. 8B, a diagram 802 showing a result of calculating a computing cycle when a PIM array is mapped in a column-major manner according to one or more embodiments is illustrated.

For example, as shown in the diagram 802, when mapping the input data onto the PIM array in column-major, the number of cycles (AR cycles) consumed to map the input data (multi-bit of 4-bits) onto the PIM array 110 in the row direction may be “1” and the number of cycles (AC cycles) consumed to map the multi-bit in the column direction of the PIM array 110 may be “1”. In this example, the number of times of loading the input data of 4-bits through the input port may be “4”.

Accordingly, as shown in the diagram 802, the computing cycle when the PIM array is mapped in the column-major manner may be calculated as 4×1×1=4.

Referring to FIG. 8A, a diagram 804 showing a result of calculating a computing cycle when a PIM array is mapped by multi-bit splitting according to one or more embodiments is illustrated.

As described above, in one or more embodiments, to increase the array utilization of a depth-wise convolutional layer, an improved column-major mapping method in which an input value is also mapped in column-major and is input in parallel may be used as shown in the diagram 804 while the array utilization may be maximized by adopting multi-bit splitting. The BS may split bits depending on a given circumstance and may arrange the bits in a PIM array rather than arranging a multi-bit value from an MSB to an LSB in the same row or column.

For example, when input data of n-bit required for an operation is given, (log₂n)+1 multi-bit splittings may exist. To determine a final method among various multi-bit splittings, the controller may compare computing cycles based on each mapping format. The computing cycle may occur because the size of a neural network (e.g., a layer) to be mapped is great compared to the size of the PIM array.

For example, when using multi-bit splitting while simultaneously using the improved column-major mapping method that maps and inputs input data in column-major in parallel as shown in the diagram 804, the number of cycles (AR cycles) consumed to map the input data (multi-bit of 4-bits) onto the PIM array 110 in the column direction may be “2” and the number of cycles (AC cycles) consumed to map the multi-bit in the column direction of the PIM array may be “1”. In this example, the number of times of loading the input data of 4-bits through the input port may be “1”.

Accordingly, when the PIM array is mapped as shown in the diagram 804, the computing cycle may be calculated as 2×1×1=2.

In one or more embodiments, by considering the mapping of an IFM of a depth-wise convolutional layer that is the subject of mapping, the improved column-major mapping method, and multi-bit splitting, Equation 1 described above may be summarized as Equation 2 below, for example.

$$Equation 2$$

$$ceil ( \frac{\#of kernel elements}{array row \text{?} size} ) \times ceil ( \frac{\#of windows in IFM}{array column size} ) \times \#of ICs$$

$$\text{?} \text{indicates text missing or illegible when filed}$$

In this example, #of kernel elements may be the number of elements that a weight kernel has. For example, #of kernel elements in a 3×3 kernel may be 9 and #of kernel elements in a 4×4 kernel may be 16. In a convolutional neural network (CNN), #of windows in IFM may be a value representing how many times a given-sized kernel is configured to slide over the IFM. For example, a 3×3 kernel may slide all areas of the entire IFM by sliding four times (two times in the width direction and two times in the height direction). Typically, the number of sliding times in the width or height direction of the IFM in the CNN may be calculated by ((IFM-kernel)/stride)+1.

In addition, ceil may denote a rounding operation and #of ICs may denote the number of input channels (ICs) of the depth-wise convolutional layer. Equation 2 may represent a computing cycle in the input-stationary data flow that is suitable to the depth-wise convolutional layer. In other words, Equation 2 may embody Equation 1 representing the computing cycle. For a detailed meaning of each term in Equation 2, a first term (ceil(#of kernel elements/array row size)) may denote an AR cycle in a mapping domain, a second term (ceil(#of windows in IFM/array column size)) may denote an AC cycle in the mapping domain, and a third term (#of ICs) may denote an input domain, in other words, the number N of loading of input data through an input port.

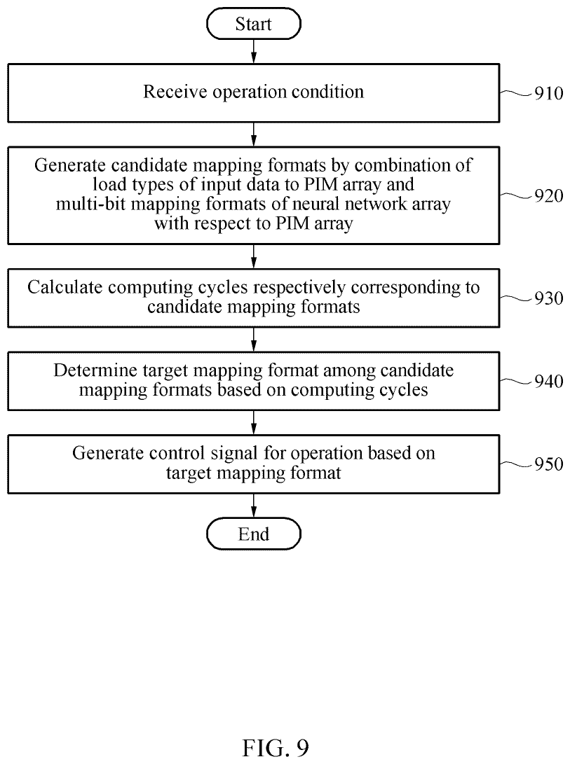

FIG. 9 is a flowchart illustrating an operation method of a PIM device according to one or more embodiments. Operations 910 to 950 in the embodiment of FIG. 9 may be performed sequentially, but not necessarily performed sequentially. For example, the order of the operations may change, at least two of the operations may be performed in parallel, one operation may be split and performed, and/or one or more of the operations may be omitted without departing from the spirit and scope of the example embodiments described herein.

Referring to FIG. 9, a PIM device in one or more embodiments may generate a control signal through operations 910 to 950.

In operation 910, the PIM device may receive an operation condition. The operation condition may include, for example, layer information including at least one of a size of a layer of a neural network array, a depth of a layer, the number of input and output channels, a kernel size, and an image size, a size of a PIM array, and the number of multi-bits to be used for an operation. However, the example is not limited thereto.

In operation 920, the PIM device may generate candidate mapping formats by a combination of load types of the input data to the PIM array and multi-bit mapping types of the neural network array with respect to the PIM array based on the operation condition received in operation 910.

In operation 930, the PIM device may calculate computing cycles respectively corresponding to the candidate mapping formats generated in operation 920. The PIM device may calculate the computing cycles respectively corresponding to the candidate mapping formats based on the number of cycles (AR cycles) consumed to map multi-bit of the neural network array in the row direction of the PIM array, the number of cycles (AC cycles) consumed to map the multi-bit in the column direction of the PIM array, the number of arrays used for mapping and the number of input times.

In operation 940, the PIM device may determine a target mapping format from the candidate mapping formats based on the computing cycle calculated in operation 930.

In operation 950, the PIM device may generate a control signal for an operation based on the target mapping format determined in operation 940. The PIM device may generate a control signal to support a mapping type of the PIM array corresponding to the target mapping format determined in operation 940 and the load type format of the input data by using an LUT including setting information about a shifting logic for performing a selective shift operation and an FA for performing an addition operation for each candidate mapping format.

The PIM device may generate a control signal to perform a selective shift operation and an addition operation on an operation result of the PIM array based on the target mapping format determined in operation 940.

The PIM device may generate a control signal to perform a shift operation by a shifting logic before an addition operation is performed by FAs in a stage of multiple stages.

The PIM device may generate a control signal for mapping the multi-bit onto the PIM array by splitting the multi-bit into various bit structures based on the target mapping format.

The PIM devices, PIM arrays, adaptive adder trees, controllers, input drivers, R/W modules, FAs, shifting logics, shifters, MUXs, accumulators, PIM device 100, PIM array 110, adaptive adder tree 130, controller 150, PIM device 400, input driver 410, R/W module 420, FAs 430, shifting logics 440, shifter 441, MUX 443, and accumulator 610 described herein, including descriptions with respect to respect to FIGS. 1-9, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-9 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processing in memory (PIM) device, comprising:
a PIM array comprising a plurality of memory cells;
a controller configured to:
determine a target mapping format from candidate mapping formats by a combination of load types of input data to the PIM array and mapping types of multi-bit of a neural network array with respect to the PIM array based on an operation condition, and
generate a control signal for an operation based on the target mapping format; and
an adaptive adder tree configured to perform a selective shift operation and an addition operation on an operation result of the PIM array based on the target mapping format.

2. The PIM device of claim 1, wherein the adaptive adder tree comprises:
according to the control signal, for each stage of multiple stages,
full adders (FAs) configured to perform the addition operation on data of odd-numbered rows of the PIM array; and
a shifting logic configured to selectively perform the shift operation on data of even-numbered rows of the PIM array.

3. The PIM device of claim 2, wherein the controller is further configured to generate and transmit the control signal to perform the shift operation by the shifting logic before the addition operation is performed by the FAs in a stage of the multiple stages.

4. The PIM device of claim 2, wherein the shifting logic reflects a weight of the multi-bit in even-numbered rows of the PIM array by the shift operation before the addition operation is performed by the FAs on each of the even-numbered rows of the PIM array based on the control signal.

5. The PIM device of claim 1, wherein the controller is further configured to:
determine computing cycles respectively corresponding to the candidate mapping formats, and
for the determining of the target mapping format, determine the target mapping format from the candidate mapping formats based on the computing cycles.

6. The PIM device of claim 5, wherein, for the determining of the computing cycles, the controller is further configured to determine the computing cycles respectively corresponding to the candidate mapping formats based on a number of cycles (array row (AR) cycles) consumed to map multi-bit of the neural network array in a row direction of the PIM array, a number of cycles (array column (AC) cycles) consumed to map the multi-bit in a column direction of the PIM array, and a number of times of loading the input data through an input port.

7. The PIM device of claim 1, wherein
the controller comprises, for each of the candidate mapping formats, a look up table (LUT) comprising setting information on a shifting logic for performing the selective shift operation and a full adder (FA) for performing the addition operation, and
for the generating of the control signal, the controller is further configured to generate the control signal corresponding to the target mapping format by using the LUT.

8. The PIM device of claim 1, wherein the controller is further configured to:
receive information about the target mapping format determined based on the operation condition from a host device, and
for the generating of the control signal, generate the control signal to perform the operation based on the information about the target mapping format.

9. The PIM device of claim 1, wherein the operation condition comprises any one or any combination of any two or more of:
layer information comprising any one or any combination of any two or more of a size of a layer of the neural network array, a depth of the layer, a number of input and output channels, a kernel size, and an image size;
a size of the PIM array; and
a number of multi-bits to be used for the operation.

10. The PIM device of claim 1, wherein
the input data comprises a kernel weight, and
the PIM array comprises an input feature map.

11. The PIM device of claim 1, wherein, for the generating of the control signal, the controller is further configured to generate the control signal to split the multi-bit into various bit structures based on the target mapping format and map the multi-bit onto the PIM array.

12. The PIM device of claim 1, wherein the load types of the input data comprise:
a first load type that loads the input data to an input port in series; and
a second load type that loads the input data to the input port in parallel.

13. The PIM device of claim 1, wherein the mapping types comprise:
a first mapping type that maps the multi-bit onto the PIM array for each row;
a second mapping type that maps the multi-bit onto the PIM array for each column; and
a third mapping type that splits and maps the multi-bit onto the PIM array.

14. A method of operating a processing in memory (PIM) device, the method comprising:
receiving an operation condition;
generating candidate mapping formats by a combination of load types of input data to a PIM array and mapping types of multi-bit of a neural network array with respect to the PIM array based on the operation condition;
determining computing cycles respectively corresponding to the candidate mapping formats;
determining a target mapping format from the candidate mapping formats based on the computing cycles; and
generating a control signal for an operation based on the target mapping format.

15. The method of claim 14, wherein the determining of the computing cycles comprises determining the computing cycles respectively corresponding to the candidate mapping formats based on a number of cycles (array row (AR) cycles) consumed to map multi-bit of the neural network array in a row direction of the PIM array, a number of cycles (array column (AC) cycles) consumed to map the multi-bit in a column direction of the PIM array, and a number of times of loading the input data through an input port.

16. The method of claim 14, wherein the generating of the control signal comprises, for each of the candidate mapping formats, generating the control signal to support a mapping type of the PIM array corresponding to the target mapping format and a load type of the input data by using a look up table (LUT) comprising setting information on a shifting logic for performing a selective shift operation and a full adder (FA) for performing an addition operation.

17. The method of claim 14, wherein the generating of the control signal comprises generating a control signal to perform a selective shift operation and an addition operation on an operation result of the PIM array based on the target mapping format.

18. The method of claim 17, wherein the generating of the control signal further comprises generating and transmitting the control signal to perform the shift operation by a shifting logic before the addition operation is performed by FAs in a stage of multiple stages.

19. The method of claim 14, wherein the generating of the control signal comprises generating the control signal to split the multi-bit into various bit structures based on the target mapping format and map the multi-bit onto the PIM array.

20. The method of claim 14, wherein the operation condition comprises any one or any combination of any two or more of:
layer information comprising any one or any combination of any two or more of a size of a layer of the neural network array, a depth of the layer, a number of input and output channels, a kernel size, and an image size;
a size of the PIM array; and
a number of multi-bits to be used for the operation.
